(19) United States
(12) Patent Application Publication
(10) Pub. No.: US 2026/0126214 A1
(43) Pub. Date: May 7, 2026

(54) DYNAMIC PROTECTANT

(71) Applicant: Joshua Leon McGuire, Amarillo, TX (US)

(72) Inventor: Joshua Leon McGuire, Amarillo, TX (US)

(73) Assignee: HYSTERION TECHNOLOGIES PLLC, AMARILLO, TX (US)

(21) Appl. No.: 19/174,596

(22) Filed: Apr. 9, 2025

Related U.S. Application Data
(60) Provisional application No. 63/716,386, filed on Nov. 5, 2024.

(51) Int. Cl. F24S 40/10; H02S 40/00

(52) U.S. Cl. CPC F24S 40/10; H02S 40/00

(57) ABSTRACT

The dynamic protection invention relates to a system and method for protecting against debris, limited chemicals, or weather-related materials making harmful contact with the product, area, or materials requiring protection.

Solar panels, products, areas, and materials are preferably exposed to their environment unless a threat to their safety and wellbeing is present. This protection mechanism and its functionality may be utilized to protect against potentially harmful impacts or otherwise harmful results associated with debris, limited chemicals, or weather-related materials. The addition of inherent self-securement of the protectant to the strong framing, if available, adds the benefit of stability against harsh winds. For instance, solar panels utilizing this protectant invention have a better chance of staying on their framing during harsh winds, since the protectant is holding the panels against the frame they are secured to.

### BACKGROUND OF THE INVENTION

### Technical Field

The present invention relates to a system and method for dynamic protection from debris, limited chemicals, or weather-related materials.

### Description of Related Art

Solar panels are becoming increasingly popular. However, many panels are easily damaged. Consequently, there is a need to better protect the solar panels.

As with solar panels, many devices, areas, and materials are preferably exposed to their environment unless a threat to their safety and wellbeing is present. This protection mechanism and its functionality may be utilized to protect against potentially harmful impacts or otherwise harmful results associated with debris, limited chemicals, or weather-related materials. Protection of materials may be solved with a tarp, or the like, but this lacks impact protection. The method of deploying such a protectant is initiated by human interaction, whereas the dynamic protectant will self-identify a threat via sensors or other inputs to automatically deploy as needed.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of the system with a rolled protectant in one embodiment;

FIG. 2 is a perspective view of an unrolled protectant in one embodiment;

FIG. 3 is a process flow chart of the mechanical actions, electrical interfacing, and software actions;

FIG. 4 is a top view of a plurality of solar panels uncovered, with the protection mechanism retracted and in its magazine;

FIG. 5 is a replication of FIG. 4, however, the plurality of solar panels are covered by a deployed protectant;

FIG. 6 is a process flow chart of the interactions between power, electronics, software, and mechanical tasks.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

Solar panels collect solar energy which can be harnessed and converted to electrical energy. Solar panels are often placed in large clusters with sometimes hundreds or thousands of panels in a single location. Unfortunately, hail, strong wind, and other falling debris can damage the solar panels. Since many solar panels are clustered together, a hail storm, as an example, can cause significant damage. Therefore, there is a need to be able to quickly deploy a protection system which can protect the solar panels from damage.

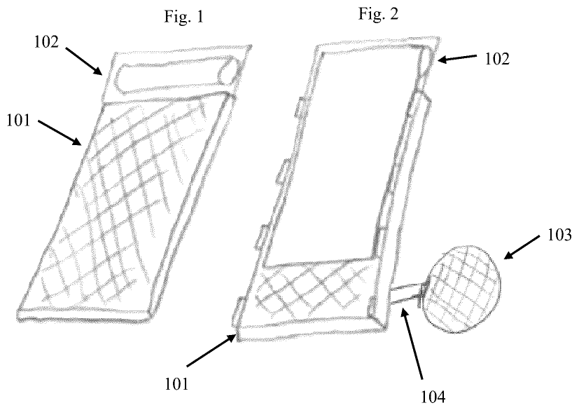

FIG. 1 is a perspective view of the system with a rolled protectant in one embodiment. The solar panels 101 can comprise virtually any type of solar panel known in the art. The solar panel 101 can comprise one large solar panel or a plurality of adjacent solar panels.

As noted, solar panels 101 are susceptible to damage or destruction through heavy hail, strong winds, and other objects. Accordingly, as shown the system utilizes a deployable protectant. The protectant 102 can be deployed to offer a layer of protection against hail, other inclement weather, and falling objects. The protectant 102 can comprise virtually any material which shields and protects the underneath solar panels 101. The protectant 102 can comprise a hard and brittle material which will reflect the hail, for example. Or the protectant 102 can comprise a soft and pliable material which absorbs the impact of the hail, for example. Throughout, the term hail will be utilized, but it should be noted that this is for illustrative purposes only. Hail can encompass virtually any type of falling material which can damage the solar panels 101. Throughout, the term solar panels will be utilized, but it should be noted this is for illustrative, yet inclusive, purposes only. Solar panels can encompass any devices, areas, or material requiring protection from a threat.

The protectant 102, in one embodiment, can be deployed when needed and retrieved thereafter. Because solar panels 101 need to be exposed to the sun to function, it is not possible to leave the protectant 102 deployed full-time. Rather, the protectant 102 can be deployed when needed and when the solar panels 101 are at risk. Thereafter, the protectant 102 is retracted to allow the solar panels 101 to be exposed to the sun.

The protectant 102 can be deployed and retrieved in a variety of ways and mechanisms. The specific mechanism will depend, in part, on the material utilized as the protectant.

As shown, the protectant 102 is rolled. In this way, the protectant 102 can be rolled and stored in a roll until it can be unraveled and deployed when needed. The roll can utilize a motor, for example, to unwind and unravel the protectant 102.

Various types of protectants 102 can be rolled. This includes soft and pliable rubber materials as well as harder materials. As can be seen, when the protectant is in the rolled position, the solar panel 101 is exposed.

As shown, the protectant 102 roll is located adjacent to the solar panel 101. As shown, the solar panels are oriented so that the length is the major axis. The protectant 102 has a width which is similar to the width of the solar panels 101. Similarly, the protectant 102 has a length which is similar to the length of the solar panel 101. In this manner, the majority of the exposed surface area of the solar panels 101 can be covered and protected by the protectant 102. In one embodiment the entirety of the exposed surface area of the solar panels 101 are covered by the protectant. As an example, the protectant 102 can comprise a width which is greater than the width of the solar panel. Similarly, the length of the protectant 102 can be greater than the length of the solar panel 101. This ensures the entirety of the exposed surface area is covered by the protectant 102.

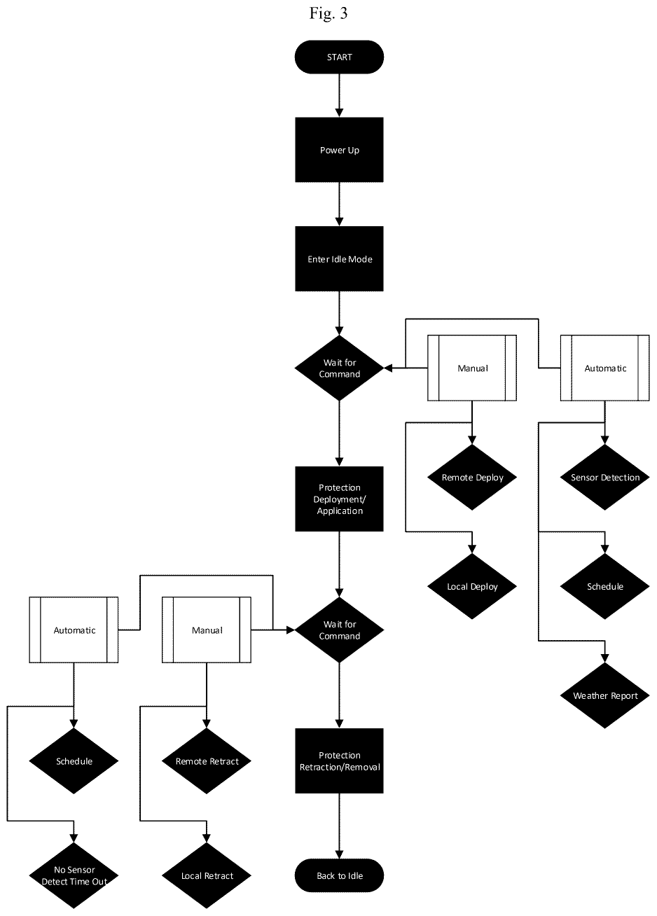

FIG. 2 is a perspective view of an unrolled protectant in one embodiment. As can be seen, the protectant 102 is unrolled so that a majority of the length of the solar panel 101 is covered by the protectant 102. A larger protectant 102 can be utilized to cover more of the solar panel 101. This figure just illustrates how the protectant 102 can be unrolled to cover the underneath solar panel 101. As shown, the sensor 103 senses inclement weather or falling debris. It is coupled to the system via a retractable arm 104. The sensor 103 communicates with the system and instructs when to deploy or retract the protectant 102. The arm 104 is not required to retract, and the placement of the arm 104 or sensing mechanism 103 represented on the arm 104 is not specific to any one location. The retractable arm may not be needed, depending on the installation criteria.

The sensor 103 can be an impact sensor, a pressure sensor, a sound sensor, a visual camera, laser, weather report, etc. Sensor 103 represents a single or multitude of sensing components to achieve threat acquisition.

It should be noted that the sensor 103 is but one component on the control system. In other embodiments, the system can deploy the protectants 102 prior to any debris being sensed by the sensor 103. If, for example, there is a prediction of strong hail, then the protectants 102 can be deployed even in the absence of a detection by the sensor.

The protectant 102 can be rolled via any method or mechanism known in the art. In one embodiment the solar panel 101 has tracks or channels which travel along its length. The protectant 102 can couple with the channels which guide and secure the protectant to the channels. In other embodiments, channels or tracks are not needed. Another method of protectant 102 extension, or extraction, may include the inflation of a hollow material. The material used for inflation can be the form of gas, liquid, or solid. This inflation may itself will provide mechanical force to unroll or elongate the protectant 102.

While one embodiment has been described wherein the protectant 102 is rolled along the length of the solar panel 101, this is for illustrative purposes only and should not be deemed limiting. In other embodiments, as an example, the protectant 102 is rolled along the width of the solar panel 101.

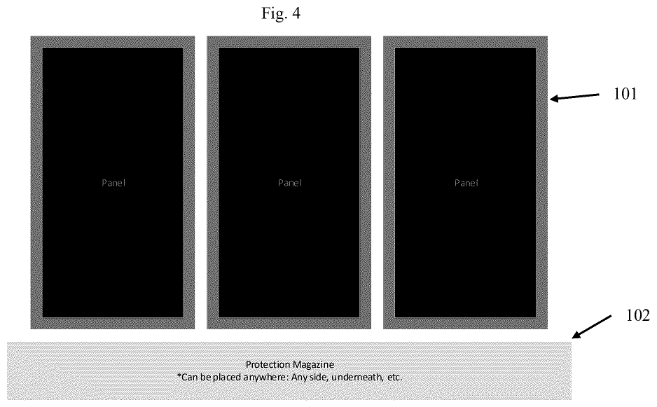

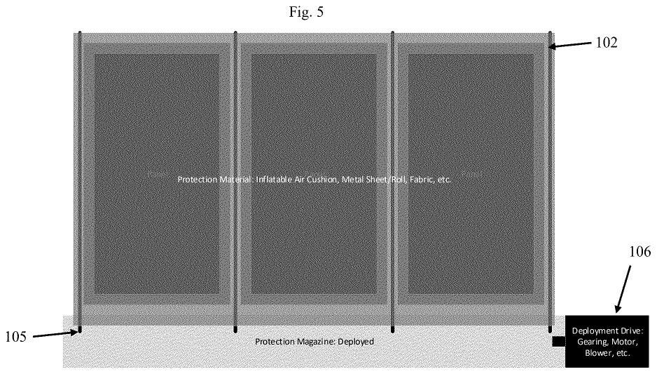

While reference has been made to a single solar panel 101, this is for illustrative purposes only and should not be deemed limiting. In one embodiment a single protectant 102 can cover and protect more than one solar panel 101. FIG. 4 is a top view of a protectant covering a plurality of solar panels 101 in one embodiment. As shown, a plurality of solar panels is placed adjacent to one another at their length. A single protectant 102 extends across several solar panels. This allows for a single protectant 102 to protect a plurality of solar panels 101. This allows for a single deployment, such as a motor, to be utilized for a plurality of solar panels 101. This reduces the overall cost of installation of the protectant 102. However, it is not limited to a single deployment method, as multiple motors or a mixture of methods may be used.

In one embodiment, software is utilized to control the protectant 102. Predetermined criteria can be met prior to deployment of the protectant 102.

FIG. 3 is an additional process flow diagram to support the methodology of the overall system. The process starts and enters an idle mode by establishing all required communications to sensors and networking paths. It will wait for a manual or automatic command before an action is taken. The action is the deployment of the protectant 102. The process will now wait for the next command of when to retract the protectant 102. This retraction command will either be manual or automatic based on sensors and software or human interaction. The process then returns to idle.

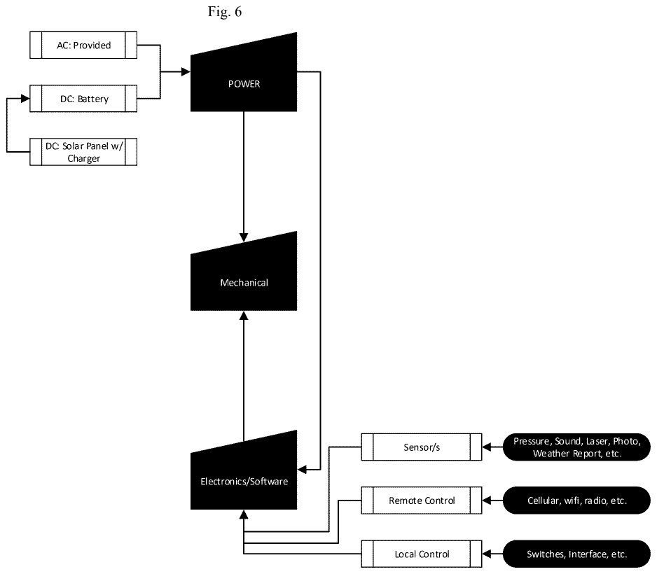

FIG. 4 is an additional illustration of uncovered/unprotected and in idle panels 101 above as compared to covered/protected 102 and in idle panels 101 in FIG. 5. The illustration also details a simple version of a deployment mechanism 106 to extend the protectant 102. Additionally, a form of cabling or rope type material 105 may be used during deployment to help deploy the protectant 102 and secure the protectant 102 to the panel/s 101. This securement method, cable or rope known in the art, will not only assist with maintaining and retraining the protectant 102 to the panel/s 101, but also provide additional securing of the panel/s 101 to the framing support for the panel/s 101. This protectant 102 provides panel/s 101 protection from impacts and assists with securing the panel/s 101 to the mounting frame the panel/s 101 are attached to. Although the bottom embodiment in FIG. 5 depicts the cabling 105 running parallel and in between the panels 101, this is for illustrative purposes only and should not be deemed limiting. For instance, the cabling 105 may be employed in any fashion that assists with holding the protectant 102 against the panels 101, while also providing support for the panels 101 to stay attached to their support mechanism.

FIG. 6 is a schematic of the power and control mechanisms. As shown, the power is converted by a solar panel, and that power is stored in a battery. The battery is in communication with a distribution tool. There is a controller and a motor controller which are coupled with a sensor. The sensor detects the presence of inclement weather, falling debris, etc. The sensor is in communication with the controller and the motor controller. The motor controller deploys the protectant 102. The motor controller also gathers the protectant 102.

While the invention has been particularly shown and described with reference to a preferred embodiment, it will be understood by those skilled in the art that various changes in form and detail may be made therein without departing from the spirit and scope of the invention.

1. A system for dynamic protection, said system comprising:
1. A system of a deployable protectant material.
2. The method of claim 1wherein said protectant rolls, folds, or fills resulting in extension or retraction of the protectant.
3. A method of deploying a protectant:
a. obtaining a signal to deploy using sensors, automation, and/or human interface.
b. providing additional securement of protected device, area, or material.
c. limiting the negative effects of a threat to the device, area, or material requiring protection.
